(19) United States
(12) Patent Application Publication
(10) Pub. No.: US 2017/0300810 A1
(43) Pub. Date: Oct. 19, 2017

(54) NEURAL NETWORK SYSTEM

(71) Applicant: SK Hynix Inc., Icheon (KR)

(72) Inventor: Hyung-Dong LEE, Hwaseong (KR)

(21) Appl. No.: 15/459,622

(22) Filed: Mar. 15, 2017

Related U.S. Application Data
(60) Provisional application No. 62/322,566, filed on Apr. 14, 2016.

(30) Foreign Application Priority Data
Oct. 24, 2016 (KR) 10-2016-0138305

(51) Int. Cl. G06N 3/063; G06N 3/08

(52) U.S. Cl. CPC G06N 3/0635; G06N 3/08

(57) ABSTRACT

A neuromorphic device includes an input device; an output device; and a neural network including a first synapse network and a second synapse network between the input device and the output device. The first synapse network includes a first synapse system having higher learning efficiency than the second synapse network, and the second synapse network includes a second synapse system having more excellent data retention capability than the first synapse network.

### CROSS-REFERENCE TO RELATED APPLICATION

This application claims priority to U.S. Provisional Patent Application No. 62/322,566, filed on Apr. 14, 2016, and Korean Patent Application No. 10-2016-0138305, filed on Oct. 24, 2016, which are incorporated herein by reference in their entirety.

### TECHNICAL FIELD

Exemplary embodiments relate to a neuromorphic device, and more particularly, to a neural network system and a neuromorphic device including the same.

### DISCUSSION OF THE RELATED ART

Recently, much attention has been paid to neuromorphic technology, which uses chips that imitate the human brain. A neuromorphic device based on the neuromorphic technology includes a plurality of pre-synaptic neurons, a plurality of post-synaptic neurons, and a plurality of synapses. The neuromorphic device outputs pulses or spikes having various levels, magnitudes, or times, according to learning states of the neuromorphic device. In order to improve the performance of a neuromorphic device, a neuromorphic element having fast learning speed, high learning efficiency, and an excellent data retention capability is demanded in the art. However, because the fast learning speed, the high learning efficiency, and the excellent data retention capability are in a trade-off relationship therebetween, it is difficult to implement all of them simultaneously.

### SUMMARY

Various embodiments are directed to a neural network system and a neuromorphic device, which have excellent learning efficiency and an excellent data retention capability.

Various objects to be achieved by the disclosure are not limited to the aforementioned objects, and those skilled in the art to which the disclosure pertains may clearly understand other objects from the following descriptions.

In an embodiment, a neuromorphic device may include: an input device; an output device; and a neural network including a first synapse network and a second synapse network, the synapse network being disposed between the input device and the output device. The first synapse network may include a first synapse system having a higher learning efficiency than the second synapse network. The second synapse network may include a second synapse system having a better data retention capability than the first synapse network.

The first synapse network may include a first synapse system and the second synapse network includes a plurality of second synapse systems, which are subordinated to the first synapse system.

The neural network may further include a third synapse network disposed between the first synapse network and the second synapse network. The third synapse network may have a better data retention capability than the first synapse network and a worse retention capability than the second synapse network. The third synapse network may have a higher learning efficiency than the second synapse network and a lower learning efficiency than the first synapse network.

The third synapse network may include a plurality of third synapse systems. The third synapse systems may be subordinated to the first synapse system.

The second synapse network may include a plurality of second synapse systems. The second synapse systems may be subordinated to one of the third synapse systems.

A data pattern learned by the first synapse network may be transmitted to the third synapse network and saved by the third synapse network.

The data pattern saved by the third synapse network may be transmitted to the first synapse network and updated by the first synapse network.

The first synapse network may exclusively learn a data pattern.

The first synapse network may be potentiated and depressed by first electrical set and reset pulses, the first set and reset pulses having a higher voltage, a larger current, a longer input time, or a larger number of input times than second electrical set and reset pulses used for potentiating and depressing the second synapse network, respectively.

The neuromorphic device may further include a pre-processor disposed between the input device and the neural network. The pre-processor may distribute a data pattern to be learned to the first synapse network.

In an embodiment, a neuromorphic device may include: an input device; a neural network electrically coupled to the input device; and an output device electrically coupled to the neural network. The neural network may include a first synapse network having a first learning speed and a second synapse network having a second learning speed that is slower than the first learning speed.

The first synapse network may include a plurality of first synapse systems that have the first learning speed. The second synapse network may include a plurality of second synapse systems that have the second learning speed.

The second synapse network may include a plurality of second synapse systems that are subordinated to the first synapse network.

The neural network may further include a third synapse network disposed between the first synapse network and the second synapse network. The third synapse network may have a third learning speed that is slower than the first learning speed and faster than the second learning speed.

The third synapse network may include a plurality of third synapse systems that are subordinated to the first synapse network.

The second synapse network may include a plurality of second synapse systems that are subordinated to the third synapse network.

The first synapse network may exclusively learn a data pattern. The data pattern learned by the first synapse network may be transmitted to the third synapse network and saved by the third synapse network.

In an embodiment, a neuromorphic device may include: an input device; a neural network electrically coupled to the input device; and an output device electrically coupled to the neural network. The neural network may include a first synapse network having a first data retention capability and a second synapse network having a second data retention capability that is better than the first data retention capability.

The neural network may further include a third synapse network disposed between the first synapse network and the second synapse network. The third synapse network may have a third data retention capability that is better than the first data retention capability and worse than the second data retention capability.

The third synapse system may be potentiated and depressed by third electrical set and reset pulses, respectively. The third electrical set and reset pulses may have a higher voltage, a larger current, a longer input time, or a larger number of input times than first electrical set and reset pulses used for potentiating and depressing the first synapse system, respectively. The third electrical set and reset pulses may have a lower voltage, a smaller current, a shorter input time, or a smaller input number of times than second electrical set and reset pulses used for potentiating and depressing the second synapse system, respectively.

The details of other embodiments are included in the detailed description and the drawings.

### BRIEF DESCRIPTION OF THE DRAWINGS

FIG. 1 is a diagram conceptually illustrating a unit synapse system of a neuromorphic device in accordance with an embodiment of the present disclosure.

FIGS. 2A to 2C are diagrams conceptually illustrating single neural network systems of neuromorphic devices in accordance with various embodiments of the present disclosure.

FIG. 3 is a diagram conceptually illustrating a single neural network system of a neuromorphic device in accordance with an embodiment of the present disclosure.

FIGS. 4A and 4B are diagrams conceptually illustrating multi-neural network systems of neuromorphic devices in accordance with embodiments of the present disclosure.

FIGS. 5A to 5C are diagrams conceptually illustrating multi-neural network systems of neuromorphic devices in accordance with embodiments of the present disclosure.

FIG. 6 is a block diagram conceptually illustrating a pattern recognition system in accordance with an embodiment of the present disclosure.

### DETAILED DESCRIPTION

In the disclosure, advantages, features and methods for achieving them will become more apparent after a reading of the following exemplary embodiments taken in conjunction with the drawings. The invention may, however, be embodied in different forms and should not be construed as limited to the embodiments set forth herein. Rather, these embodiments are provided so that this disclosure will be thorough and complete, and will fully convey the scope of the invention to those skilled in the art.

Terms used in this specification are used for describing various embodiments, and do not limit the invention. As used herein, a singular form is intended to include plural forms as well, unless the context clearly indicates otherwise. It will be further understood that the terms ‘includes’ and/or ‘including,’ when used in this specification, specify the presence of at least one stated feature, step, operation, and/or element, but do not preclude the presence or addition of one or more other features, steps, operations, and/or elements thereof.

When one element is referred to as being ‘connected to’ or ‘coupled to’ another element, it may indicate that the former element is directly connected or coupled to the latter element or another element is interposed therebetween. On the other hand, when one element is referred to as being ‘directly connected to’ or ‘directly coupled to’ another element, it may indicate that no element is interposed therebetween. Furthermore, ‘and/or’ includes each of described items and one or more combinations.

The terms such as ‘below’, ‘beneath’, ‘lower’, ‘above’ and ‘upper’, which are spatially relative terms, may be used to describe the correlation between one element or components and another element or other components, as illustrated in the drawings. The spatially relative terms should be understood as terms including different directions of elements during the use or operation, in addition to the directions illustrated in the drawings. For example, when an element illustrated in a drawing is turned over, the element which is referred to as being ‘below’ or ‘beneath’ another element may be positioned above another element.

Throughout the specification, like reference numerals refer to like elements. Therefore, although the same or similar reference numerals are not mentioned or described in a corresponding drawing, the reference numerals may be described with reference to other drawings. Furthermore, although elements are not represented by reference numerals, the elements may be described with reference to other drawings.

In this specification, ‘potentiation,’ ‘set,’ ‘training,’ and ‘learning’ may be used as the same or similar terms, and ‘depressing,’ ‘reset,’ and ‘initiation’ may be used as the same or similar terms. For example, an operation of lowering resistance values of synapses may be exemplified as potentiation, setting, or learning, and an operation of raising the resistance values of the synapses may be exemplified as depressing, resetting, or initiation. Furthermore, when a synapse is potentiated, set, or learned, a gradually increasing voltage/current may be outputted from the synapse because the conductivity of the synapse is increasing. When a synapse is depressed, reset, or initiated, a gradually decreasing voltage/current may be outputted from the synapse because the conductivity of the synapse is decreasing. For convenience of description, a data pattern, an electrical signal, a pulse, a spike, and a firing may be interpreted as having the same, similar, or a compatible meaning. Furthermore, a voltage and a current may also be interpreted as having the same or a compatible meaning.

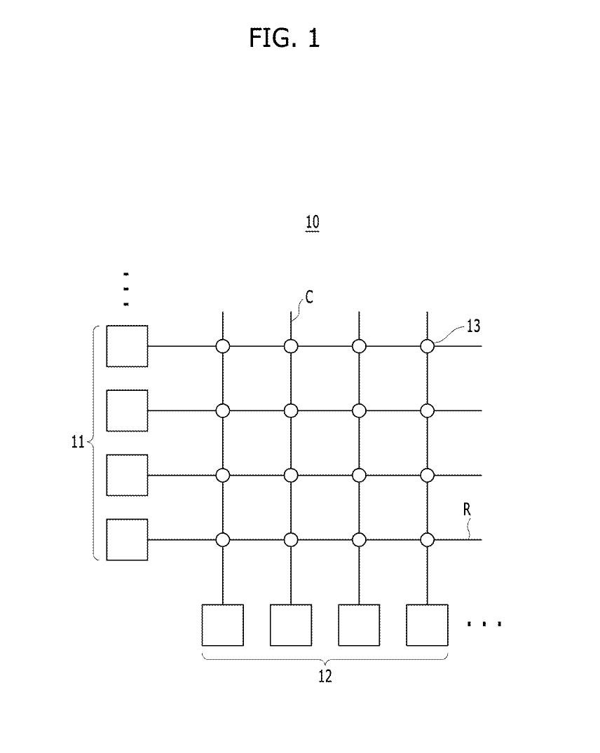

FIG. 1 is a diagram conceptually illustrating a unit synapse system 10 of a neuromorphic device in accordance with an embodiment of the present disclosure.

Referring to FIG. 1, the unit synapse system 10 may include a plurality of pre-synaptic neurons 11, a plurality of post-synaptic neurons 12, and a plurality of synapses 13.

The synapses 13 may be disposed at intersection regions of row lines R, which extend in a row direction from respective ones of the pre-synaptic neurons 11, and column lines C, which extend in a column direction from respective ones of the post-synaptic neurons 12.

The pre-synaptic neurons 11 may transmit electrical pulses to the synapses 13 through the row lines R in a learning mode, a reset mode, or a reading mode.

The post-synaptic neurons 12 may transmit electrical pulses to the synapses 13 through the column lines C in the learning mode or the reset mode, and may receive electrical pulses from the synapses 13 through the column lines C in the reading mode.

Each of the synapses 13 may include a variable resistance element such as a diode. For example, each of the synapses 13 may include a first electrode, which is electrically coupled to a corresponding pre-synaptic neuron 11, and a second electrode, which is coupled to a corresponding post-synaptic neuron 12. Each of the synapses 13 may have multiple resistance levels.

In embodiments of the present disclosure, a neuromorphic device may include a neural network system, and may use a single neuromorphic chip or a plurality of neuromorphic chips.

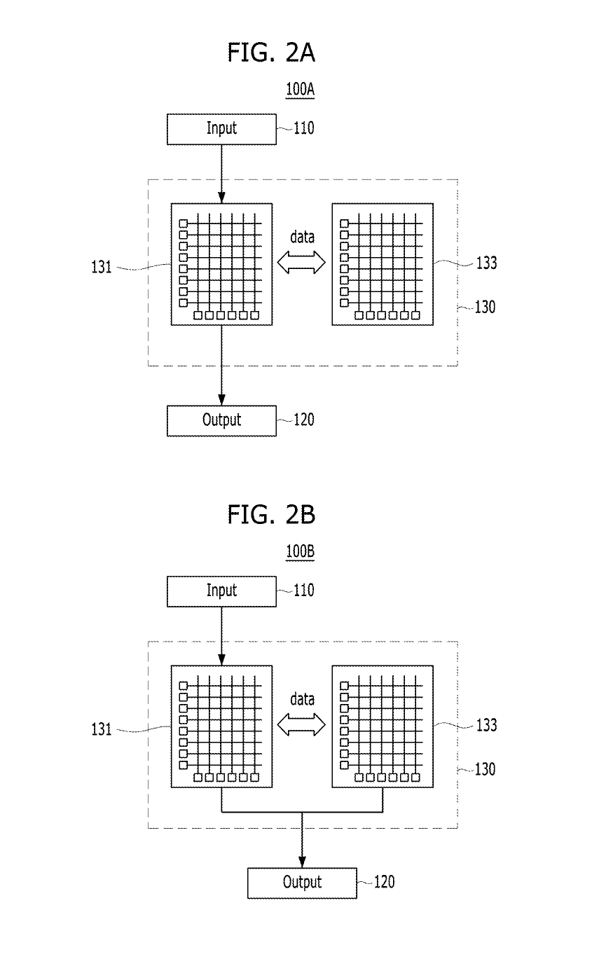

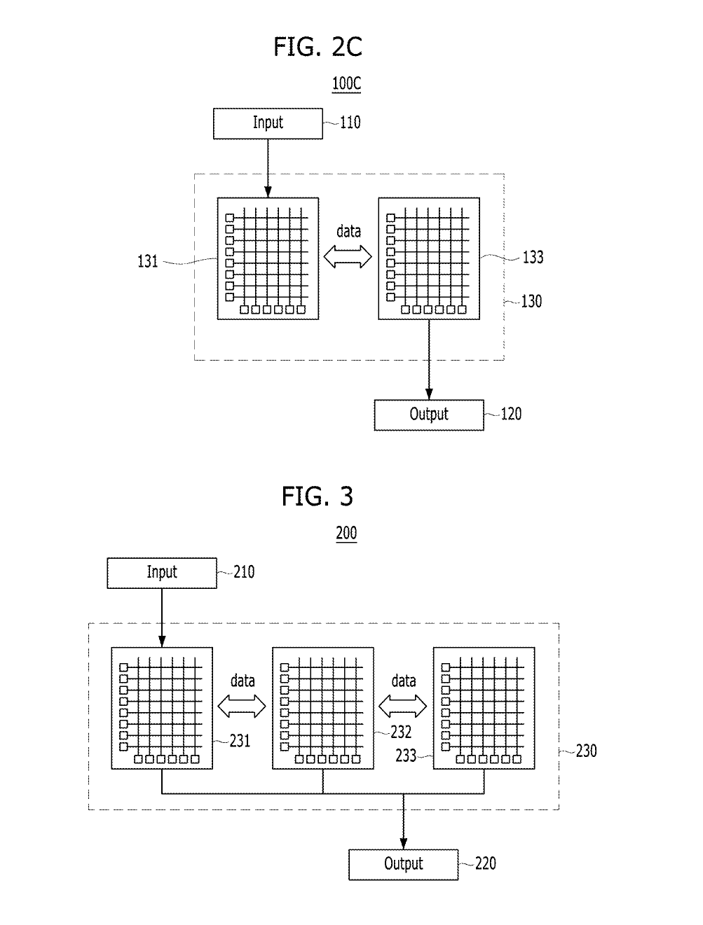

FIGS. 2A to 2C are diagrams conceptually illustrating single neural network systems 100A to 100C of neuromorphic devices in accordance with various embodiments of the present disclosure.

Referring to FIG. 2A, the single neural network system 100A may include an input device 110, an output device 120, and a synapse network 130. The synapse network 130 may include a short-term synapse system 131 and a long-term synapse system 133.

The input device 110 may include at least one of various input units to input a data pattern to the synapse network 130. Specifically, the input device 110 may include one or more of a keyboard, a mouse, a touch panel and pencil, an optical reader, a sensor, a scanner, a camera, a microphone, a microprocessor, and so on.

The output device 120 may include at least one of various output units for outputting a data pattern from the synapse network 130. Specifically, the output device 120 may include one or more of a monitor, a printer, a display panel, an emitter, a speaker, a mechanical device, a microprocessor, and so on.

The short-term synapse system 131 may include a synapse system including synapses. The short-term synapse system 131 may have a relatively excellent learning efficiency, compared to the long-term synapse system 133. For example, the short-term synapse system 131 may have a resistance value that changes more sensitively, a faster switching speed, or a smaller physical size than the long-term synapse system 133. That is, the short-term synapse system 131 may be potentiated and depressed by electrical set/reset pulses which have a lower voltage, a smaller current, a shorter input time, and/or a smaller input number of times than electrical set/reset pulses used for potentiating/depressing the long-term synapse system 133.

The long-term synapse system 133 may include a synapse system including synapses, which has a relatively excellent data retention capability and a long data retention time, compared to the short-term synapse system 131. For example, the long-term synapse system 133 may have a resistance value that changes less sensitively, a slower resistance change speed, and a larger physical size than the short-term synapse system 131. That is to say, the long-term synapse system 133 may be potentiated and depressed by electrical set/reset pulses which have a higher voltage, a larger current, a longer input time, and/or a larger input number of times than the electrical set/reset pulses used for potentiating/depressing the short-term synapse system 131. The long-term synapse system 133 may have a lower set/reset change rate than the short-term synapse system 131. Also, the long-term synapse system 133 may retain saved data patterns without a refresh process for a longer time than the short-term synapse system 131.

In the learning mode, a data pattern inputted from the input device 110 may be inputted to the short-term synapse system 131, and learned by the short-term synapse system 131. In other words, in the learning mode, the data pattern may be inputted only to the short-term synapse system 131, not to the long-term synapse system 133, and learned by only the short-term synapse system 131, not by the long-term synapse system 133.

In a completely learned state or a standby state, the learned data pattern, that is, a synapse weight of the short-term synapse system 131, may be frequently or periodically transmitted to the long-term synapse system 133, or copied, saved, or backed up by the long-term synapse system 133. The standby state may be a state in which a data pattern is not inputted to the short-term synapse system 131.

In an update mode, the data pattern saved or backed up by the long-term synapse system 133 may be retransmitted to the short-term synapse system 131, or recopied by the short-term synapse system 131. In other words, the data pattern, which was transmitted to the long-term synapse system 133, or copied, saved, or backed up by the long-term synapse system 133 from the short-term synapse system 131, may be frequently or periodically retransmitted to the short-term synapse system 131, or recopied by the short-term synapse system 131 from the long-term synapse system 133. The synapse weight, i.e., the retransmitted or recopied data pattern, may be updated by the short-term synapse system 131. The updated data pattern may be transmitted to the long-term synapse system 133, or copied, saved, or backed up by the long-term synapse system 133. Therefore, learning and updating of the data pattern may be performed only in the short-term synapse system 131.

In a recognition mode, the data pattern may be transmitted to the short-term synapse system 131 from the long-term synapse system 133, or copied by the short-term synapse system 131 from the long-term synapse system 133. The output device 120 may receive the learned data pattern from the short-term synapse system 131, and output the learned data pattern. That is, the short-term synapse system 131 may exclusively provide the learned data pattern to the output device 120.

In the neuromorphic device in accordance with the embodiment, a data pattern may be learned by only the short-term synapse system 131, and may be output using the short-term synapse system 131. In this embodiment, the long-term synapse system 133 may be used to save or back up the data pattern learned by the short-term synapse system 131.

According to the embodiment, since a data pattern is inputted and outputted by using the short-term synapse system 131 which is sensitive and is able to operate with a low voltage and a small current, a data pattern transmission speed may be fast, and power consumption for data learning may be reduced.

In addition, according to the embodiment, since a data pattern is saved or copied by using the long-term synapse system 133, which has an excellent data retention capability, a process for inspecting and recovering the data pattern, such as a refresh process, does not need to be performed often. Thus, the data pattern may be retained stably for a long time, and power consumption for data retention may be reduced.

Referring to FIG. 2B, the single neural network system 100B may include the same components as those of the embodiment shown in FIG. 2A. In the single neural network system 1008, both the short-term synapse system 131 and the long-term synapse system 133 are connected to the output device 120. Therefore, the single neural network system 100B may output a learned data pattern by using one or both of the short-term synapse system 131 and the long-term synapse system 133, while the single neural network system 100A of the neuromorphic device shown in FIG. 2A outputs the learned data pattern by using only the short-term synapse system 131, not by using the long-term synapse system 133.

That is, in a recognition mode or an output mode, the output device 120 may bring the learned data pattern from one or both of the short-term synapse system 131 and the long-term synapse system 133, and output the learned data pattern. In the recognition mode or an update mode, the learned data pattern may be saved or backed up by the long-term synapse system 133, and may be frequently or periodically transmitted to the short-term synapse system 131, or copied by the short-term synapse system 131 from the long-term synapse system 133. According to the embodiment, since the learned data pattern may also be outputted by using the long-term synapse system 133, which has an excellent data retention capability, the precision of the learned data pattern to be outputted may be excellent. As used herein, a system has an excellent data retention capability when the system can accurately output a data pattern after the data pattern has been stored in the system. If a first system outputs a learned data pattern less accurately than a second system, the first system has a worse data retention capability than the second system, and the second system has a better data retention capability than the first system.

Referring to FIG. 2C, the single neural network system 100C may include the same components as those of the embodiment shown in FIG. 2A. In the single neural network system 100C, the long-term synapse system 133 is exclusively connected to the output device 120. Therefore, the single neural network system 100C may learn a data pattern using the short-term synapse system 131, but output a learned data pattern by using only the long-term synapse system 133. In other words, in a recognition mode, the output device 120 may bring the learned data pattern from the long-term synapse system 133, and output the learned data pattern. According to the embodiment, since the data pattern is learned in a learning mode by the short-term synapse system 131, which has excellent learning efficiency, a learning time of the neuromorphic device may be shortened. Moreover, since the learned data pattern is outputted in the recognition mode by the long-term synapse system 133 having an excellent data retention capability, the precision of the learned data pattern to be outputted may be excellent.

FIG. 3 is a diagram conceptually illustrating a single neural network system 200 of a neuromorphic device in accordance with an embodiment of the present disclosure.

Referring to FIG. 3, the single neural network system 200 may include an input device 210, an output device 220, and a synapse network 230. The synapse network 230 may include a short-term synapse system 231, a middle-term synapse system 232, and a long-term synapse system 233 that are connected to the output device 220.

The middle-term synapse system 232 may have characteristics between characteristics of the short-term synapse system 231 and characteristics of the long-term synapse system 233. Specifically, the middle-term synapse system 232 may have a lower learning efficiency and a better data retention capability than the short-term synapse system 231. The middle-term synapse system 232 may have a higher learning efficiency and a worse data retention capability than the long-term synapse system 233.

In addition, the middle-term synapse system 232 may be potentiated and depressed by electrical set/reset pulses which have a higher voltage, a larger current, a longer input time, and/or a larger number of input times than the short-term synapse system 231, and may be potentiated and depressed by electrical set/reset pulses that have a lower voltage, a smaller current, a shorter input time, and/or a smaller number of input times than the long-term synapse system 233.

A data pattern learned by the short-term synapse system 231 may be temporarily transmitted to the middle-term synapse system 232, or may be copied, saved, or backed up by the middle-term synapse system 232. When the learned data pattern should be updated or outputted frequently, the learned data pattern may be temporarily saved or backed up by the middle-term synapse system 232. On the other hand, when the learned data pattern should be updated or outputted rarely, the learned data pattern may be semi-permanently transmitted to the long-term synapse system 233, or copied, saved, or backed up by the long-term synapse system 233. After the learned data pattern is transmitted to the long-term synapse system 233, or copied, saved, or backed up by the long-term synapse system 233, the learned data pattern existing in the middle-term synapse system 232 may be reset.

In this embodiment, the data pattern may be learned and updated by only the short-term synapse system 231. However, the learned data pattern may be outputted from one, two, or all of the short-term synapse system 231, the middle-term synapse system 232, and the long-term synapse system 233, since all of the short-term synapse system 231, the middle-term synapse system 232, and the long-term synapse system 233 are connected to the output device 220. In some embodiments of the present disclosure, the learned data pattern may be outputted from one or both of the middle-term synapse system 232 and the long-term synapse system 233.

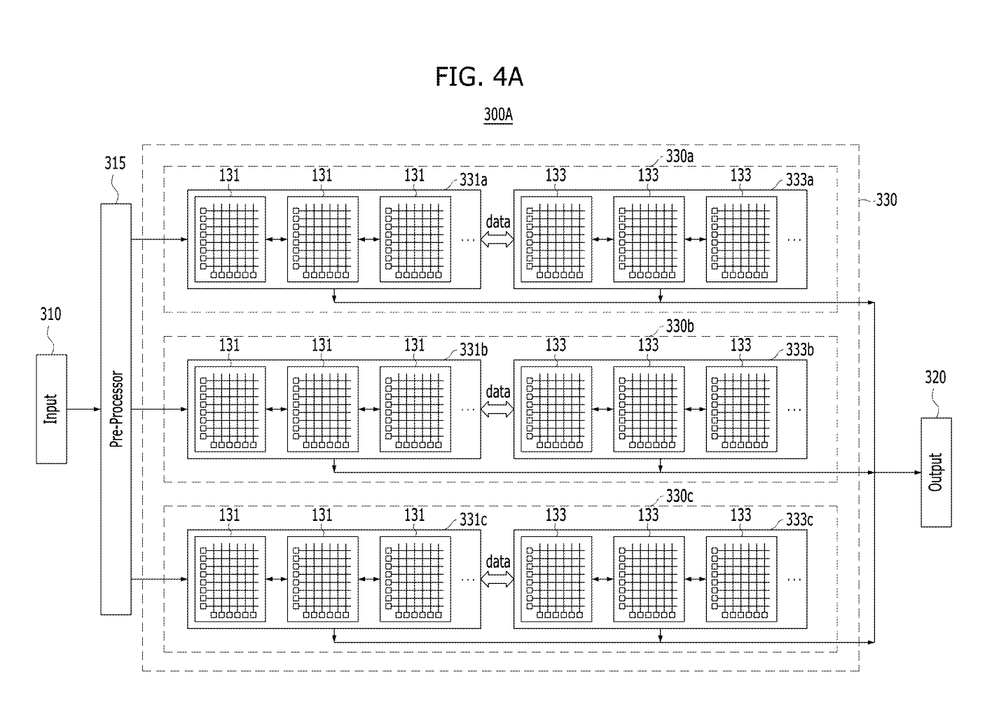

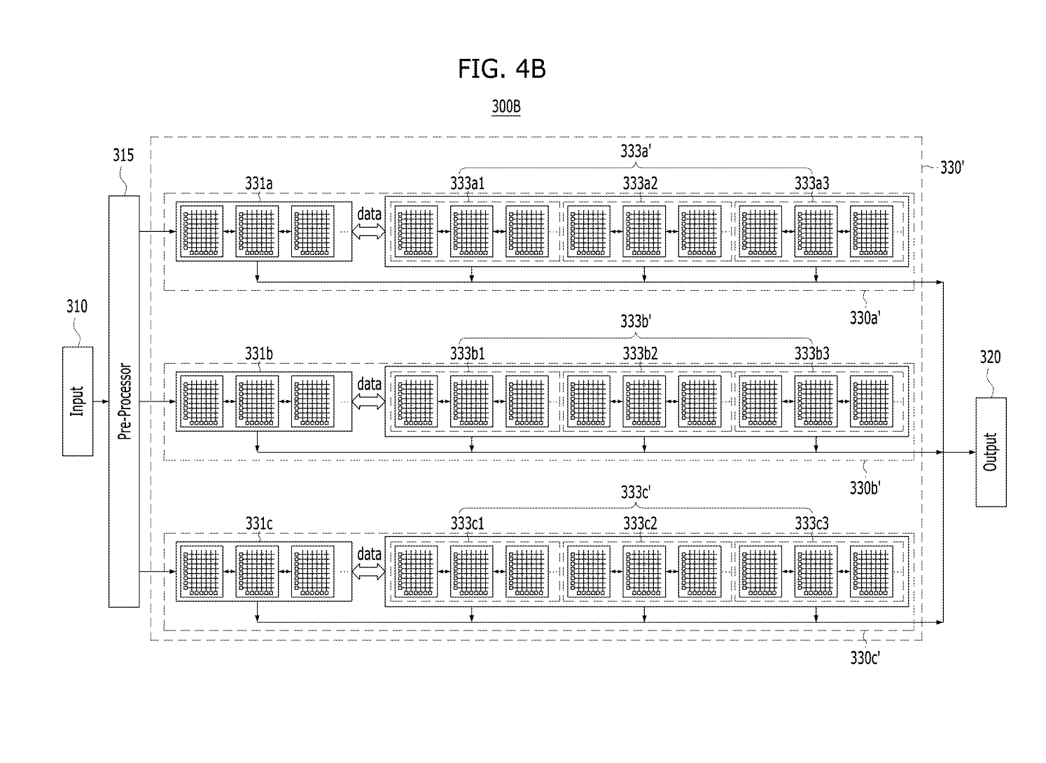

FIGS. 4A and 4B are diagrams conceptually illustrating multi-neural network systems 300A and 300B of neuromorphic devices, respectively, in accordance with embodiments of the present disclosure.

Referring to FIG. 4A, the multi-neural network system 300A may include an input device 310, an output device 320, and a synapse network 330. The synapse network 330 may include a plurality of unit synapse networks 330a to 330c. The unit synapse networks 330a to 330c may include multiple short-term synapse networks 331a to 331c and multiple long-term synapse networks 333a to 333c. When referring additionally to FIGS. 2A to 2C, each of the multiple short-term synapse networks 331a to 331c may include a plurality of short-term synapse systems 131, and each of the multiple long-term synapse networks 333a to 333c may include a plurality of long-term synapse systems 133.

The multi-neural network system 300A may further include a pre-processor 315. The pre-processor 315 may receive data patterns to be learned from the input device 310, and distribute the data patterns to the respective unit synapse networks 330a to 330c.

In a learning mode, the data patterns to be learned may be inputted to and learned by the short-term synapse networks 331a to 331c.

After the learning mode is completed, the data patterns learned by the short-term synapse networks 331a to 331c may be transmitted to the long-term synapse networks 333a to 333c, or copied, saved, or backed up by the long-term synapse networks 333a to 333c, respectively.

In an update mode, the data patterns transmitted to the long-term synapse networks 333a to 333c, or copied, saved, or backed up by the long-term synapse networks 333a to 333c may be frequently or periodically retransmitted to the short-term synapse networks 331a to 331c, or recopied by the short-term synapse networks 331a to 331c, respectively. The data patterns retransmitted to the short-term synapse networks 331a to 331c, or recopied by the short-term synapse networks 331a to 331c may be updated by the short-term synapse networks 331a to 331c, respectively. Namely, synapse weights may be updated by the short-term synapse networks 331a to 331c.

In a recognition mode, the data patterns may be outputted from one or both of the short-term synapse networks 331a to 331c and the long-term synapse networks 333a to 333c.

Referring to FIG. 4B, the multi-neural network system 300B may include an input device 310, an output device 320, a synapse network 330′, and a pre-processor 315. The synapse network 330′ may include unit synapse networks 330a′ to 330c′ respectively including a corresponding one of short-term synapse networks 331a to 331c and a corresponding one of long-term synapse networks 333a′ to 333c′. The long-term synapse networks 333a′ to 333c′ may include a plurality of long-term synapse networks 333a1 to 333a3, a plurality of long-term synapse networks 333b1 to 333b3, and a plurality of long-term synapse networks 333c1 to 333c3, respectively. Each of the plurality of long-term synapse networks 333a1 to 333a3, 333b1 to 333b3, and 333c1 to 333c3 may include a plurality of long-term synapse systems. Each of the plurality of long-term synapse systems may correspond to the long-term synapse system 133 illustrated in FIGS. 2A to 2C.

That is, the multi-neural network system 300B may include the short-term synapse networks 331a to 331c, and the pluralities of long-term synapse networks 333a1 to 333a3, 333b1 to 333b3, and 333c1 to 333c3, which are respectively subordinated to the short-term synapse networks 331a to 331c.

In a learning mode, a data pattern to be learned may be inputted to and learned by one of the short-term synapse networks 331a to 331c.

If the learning mode is completed, the data pattern learned by one of the short-term synapse networks 331a to 331c may be transmitted to a corresponding one of the pluralities of long-term synapse networks 333a1 to 333a3, 333b1 to 333b3, and 333c1 to 333c3, or copied, saved, or backed up by the corresponding one of the pluralities of long-term synapse networks 333a1 to 333a3, 333b1 to 333b3, and 333c1 to 333c3.

In an update mode, the data pattern transmitted to or copied by the corresponding one of the pluralities of long-term synapse networks 333a1 to 333a3, 333b1 to 333b3, and 333c1 to 333c3 may be retransmitted to a corresponding one of the short-term synapse networks 331a to 331c, or recopied by the corresponding one of the short-term synapse networks 331a to 331c. A synapse weight of the retransmitted or recopied data pattern may be updated by the corresponding one of the short-term synapse networks 331a to 331c. The completely updated data pattern may be retransmitted to the corresponding one of the pluralities of long-term synapse networks 333a1 to 333a3, 333b1 to 333b3, and 333c1 to 333c3, or copied, saved, or backed up by the corresponding one of the pluralities of long-term synapse networks 333a1 to 333a3, 333b1 to 333b3, and 333c1 to 333c3.

In a recognition mode, the data pattern may be outputted from one or both of the corresponding one of the short-term synapse networks 331a to 331c and the corresponding one of the pluralities of long-term synapse networks 333a1 to 333a3, 333b1 to 333b3, and 333c1 to 333c3. In another embodiment of the present disclosure, a set of data patterns may be outputted by one of the pluralities of long-term synapse networks 333a1 to 333a3, 333b1 to 333b3, and 333c1 to 333c3.

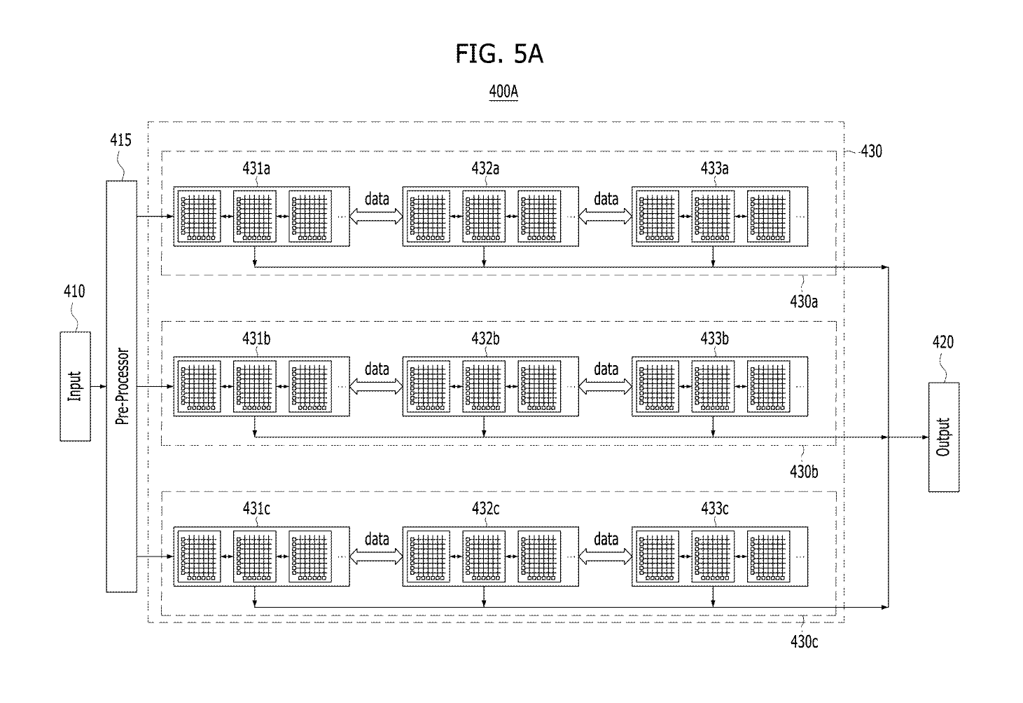

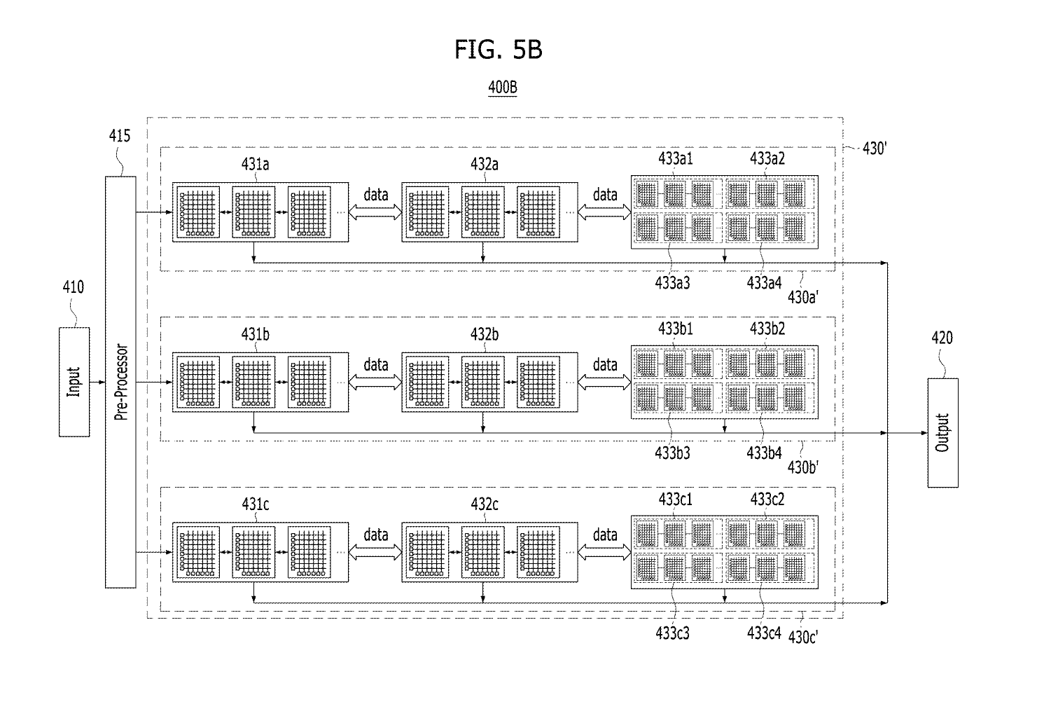

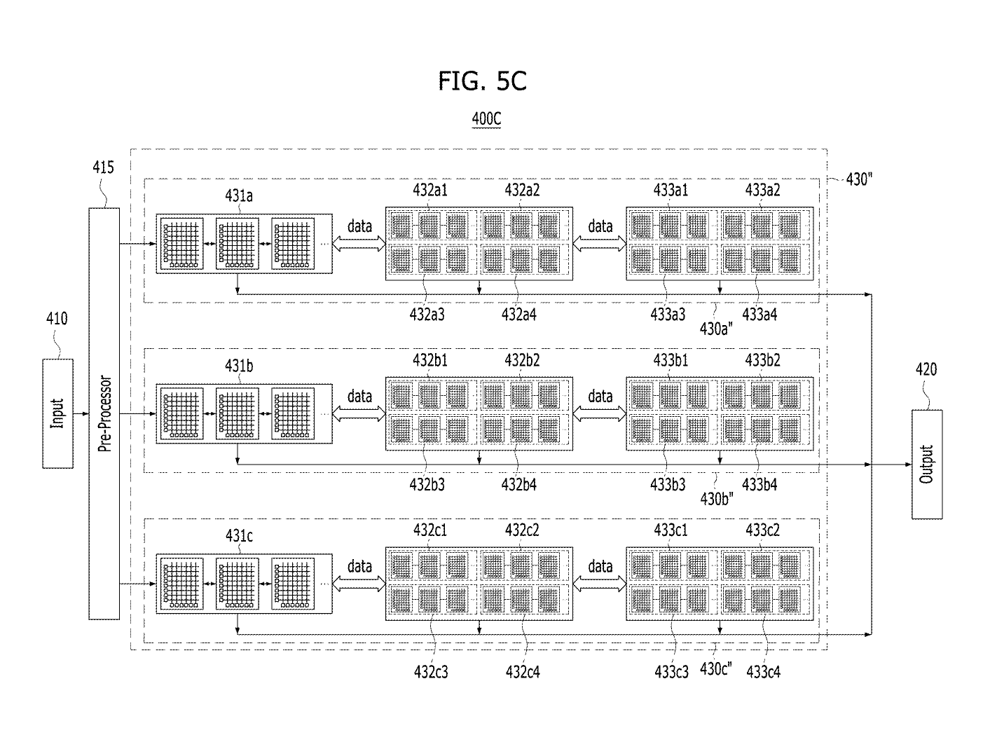

FIGS. 5A to 5C are diagrams conceptually illustrating multi-neural network systems 400A to 400C of neuromorphic devices in accordance with embodiments of the present disclosure, respectively.

Referring to FIG. 5A, the multi-neural network system 400A may include an input device 410, a pre-processor 415, an output device 420, and a synapse network 430. The synapse network 430 may include a plurality of unit synapse networks 430a to 430c. The unit synapse networks 430a to 430c may include short-term synapse networks 431a to 431c, middle-term synapse networks 432a to 432c, and long-term synapse networks 433a to 433c. Each of the short-term synapse networks 431a to 431c may include a plurality of short-term synapse systems, each of the middle-term synapse networks 432a to 432c may include a plurality of middle-term synapse systems, and each of the long-term synapse networks 433a to 433c may include a plurality of long-term synapse systems.

Data patterns may be distributed to the unit synapse networks 430a to 430c by the pre-processor 415. In a learning mode, each of the data patterns may be learned by a corresponding one of the short-term synapse networks 431a to 431c. The data patterns learned by the short-term synapse networks 431a to 431c may be temporarily transmitted to the middle-term synapse networks 432a to 432c, or copied, saved, or backed up by the middle-term synapse networks 432a to 432c. When the data patterns should be updated or outputted frequently, the data patterns may be saved or backed up by the middle-term synapse networks 432a to 432c. On the other hand, when the data patterns should be updated or outputted rarely, the data patterns may be semi-permanently transmitted to the long-term synapse networks 433a to 433c, or copied, saved, or backed up by the long-term synapse networks 433a to 433c. After the data patterns are transmitted to the long-term synapse networks 433a to 433c, or copied, saved, or backed up by the long-term synapse networks 433a to 433c, the data patterns stored in the middle-term synapse networks 432a to 432c may be reset.

Data patterns may be learned and updated by only the short-term synapse networks 431a to 431c, not by the long-term synapse networks 433a to 433c. However, the learned data patterns may be outputted from one, two, or all of the short-term synapse networks 431a to 431c, the middle-term synapse networks 432a to 432c, and the long-term synapse networks 433a to 433c. In another embodiment of the present disclosure, data patterns may be outputted from one or both of the middle-term synapse networks 432a to 432c and the long-term synapse networks 433a to 433c.

Referring to FIG. 5B, the multi-neural network system 400B may include an input device 410, a pre-processor 415, an output device 420, and a synapse network 430′. The synapse network 430′ may include a plurality of synapse networks 430a′, 430b′, and 430c′. The plurality of synapse networks 430a′, 430b′, and 430c′ may include short-term synapse networks 431a to 431c, middle-term synapse networks 432a to 432c respectively subordinated to the short-term synapse networks 431a to 431c, and pluralities of long-term synapse networks 433a1 to 433a4, 433b1 to 433b4, and 433c1 to 433c4 respectively subordinated to the middle-term synapse networks 432a to 432c. Each of the long-term synapse networks 433a1 to 433a4, 433b1 to 433b4, and 433c1 to 433c4 may include a plurality of long-term synapse systems.

Data patterns learned by the short-term synapse networks 431a to 431c may be temporarily transmitted to the middle-term synapse networks 432a to 432c, or copied, saved, or backed up by the middle-term synapse networks 432a to 432c. The middle-term synapse networks 432a to 432c may temporarily save the data patterns to be updated or recognized frequently. After the data patterns are updated or when the data patterns do not need to be updated, the data patterns may be semi-permanently transmitted to the pluralities of long-term synapse networks 433a1 to 433a4, 433b1 to 433b4, and 433c1 to 433c4, or copied, saved, or backed up by the pluralities of long-term synapse networks 433a1 to 433a4, 433b1 to 433b4, and 433c1 to 433c4. The other operations of this embodiment, which are not described herein, may be understood from the other embodiments described above.

Referring to FIG. 5C, the multi-neural network system 400C may include an input device 410, a pre-processor 415, an output device 420, and a synapse network 430″. The synapse network 430″ may include a plurality of synapse networks 430a″, 430b″, and 430c″. The plurality of synapse networks 430a″, 430b″, and 430c″ may include short-term synapse networks 431a to 431c, pluralities of middle-term synapse networks 432a1 to 432a4, 432b1 to 432b4, and 432c1 to 432c4, and pluralities of long-term synapse networks 433a1 to 433a4, 433b1 to 433b4, and 433c1 to 433c4. Each of the middle-term synapse networks 432a1 to 432a4, 432b1 to 432b4, and 432c1 to 432c4 may include a plurality of middle-term synapse systems.

Data patterns learned by the short-term synapse networks 431a to 431c may be temporarily transmitted to the pluralities of middle-term synapse networks 432a1 to 432a4, 432b1 to 432b4, and 432c1 to 432c4, or copied, saved, or backed up by the pluralities of middle-term synapse networks 432a1 to 432a4, 432b1 to 432b4, and 432c1 to 432c4. That is, advantages of using the middle-term synapse networks may be provided when a plurality of data patterns should be updated frequently. Similarly, after the data patterns are updated or when the data patterns do not need to be updated, the data patterns may be semi-permanently transmitted to the pluralities of long-term synapse networks 433a1 to 433a4, 433b1 to 433b4, and 433c1 to 433c4, or copied, saved, or backed up by the pluralities of long-term synapse networks 433a1 to 433a4, 433b1 to 433b4, and 433c1 to 433c4. The other operations of this embodiment, which are not described herein, may be understood from the other embodiments described above.

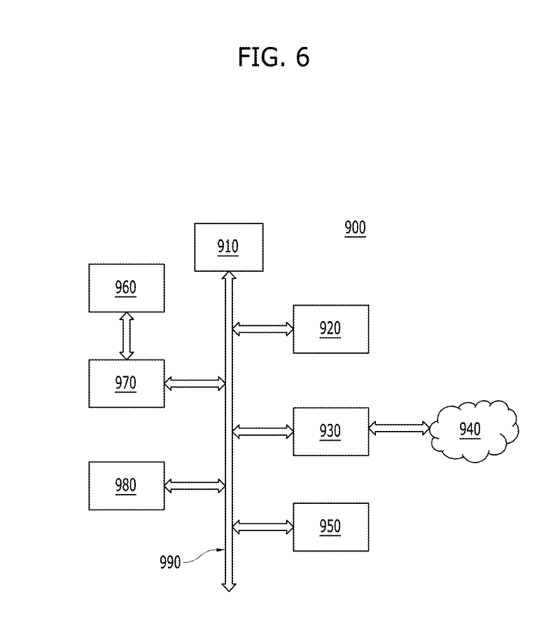

FIG. 6 is a block diagram conceptually illustrating a pattern recognition system 900 in accordance with an embodiment of the present disclosure. For example, the pattern recognition system 900 may include one of a speech recognition system, an image recognition system, a code recognition system, a signal recognition system, and a system for recognizing various patterns.

Referring to FIG. 6, the pattern recognition system 900 may include a central processing unit (CPU) 910, a memory unit 920, a communication control unit 930, a network 940, an output unit 950, an input unit 960, an analog-digital converter (ADC) 970, a neuromorphic unit 980, and a bus 990. The CPU 910 may generate and transmit various signals for a learning process to be performed by the neuromorphic unit 980, and perform a variety of processes and functions for recognizing patterns such as voices and images according to an output of the neuromorphic unit 980.

The CPU 910 may be connected to the memory unit 920, the communication control unit 930, the output unit 950, the ADC 970, and the neuromorphic unit 980 through the bus 990.

The memory unit 920 may store information in accordance with operations of the pattern recognition system 900. The memory unit 920 may include one or more of a volatile memory element such as DRAM or SRAM, a nonvolatile memory element such as PRAM, MRAM, ReRAM, or NAND flash memory, and a memory unit such as an HDD (Hard Disk Drive) or an SSD (Solid State Drive).

The communication control unit 930 may transmit and/or receive data such as a recognized voice and image to and/or from a communication control unit of another system through the network 940.

The output unit 950 may output the data such as the recognized voice and image using various methods. For example, the output unit 950 may include one or more of a speaker, a printer, a monitor, a display panel, a beam projector, a hologrammer, and so on.

The input unit 960 may include one or more of a microphone, a camera, a scanner, a touch pad, a keyboard, a mouse, a mouse pen, a sensor, and so on.

The ADC 970 may convert analog data transmitted from the input unit 960 into digital data.

The neuromorphic unit 980 may perform learning and recognition using the data transmitted from the ADC 970, and output data corresponding to a recognized pattern. The neuromorphic unit 980 may include one or more of the neuromorphic devices in accordance with the various embodiments of the present disclosure.

According to the technical spirit of the present disclosure, a neuromorphic device including a neural network system having excellent learning efficiency and a neural network system having an excellent data retention capability may be provided. As a consequence, it is possible to provide a neuromorphic device having fast learning speed, low power consumption, and an excellent data retention capability.

Although various embodiments have been described for illustrative purposes, it will be apparent to those skilled in the art that various changes and modifications may be made without departing from the spirit and scope of the invention as defined in the following claims.

What is claimed is:

1. A neuromorphic device comprising:
an input device;
an output device; and
a neural network including a first synapse network and a second synapse network, the synapse network being disposed between the input device and the output device,
wherein the first synapse network includes a first synapse system having a higher learning efficiency than the second synapse network, and
wherein the second synapse network includes a second synapse system having a better data retention capability than the first synapse network.

2. The neuromorphic device according to claim 1, wherein the first synapse network includes a first synapse system and the second synapse network includes a plurality of second synapse systems, which are subordinated to the first synapse system.

3. The neuromorphic device according to claim 1,
wherein the neural network further includes a third synapse network disposed between the first synapse network and the second synapse network, and
wherein the third synapse network has a better data retention capability than the first synapse network and a worse retention capability than the second synapse network, the third synapse network having a higher learning efficiency than the second synapse network and a lower learning efficiency than the first synapse network.

4. The neuromorphic device according to claim 3, wherein the third synapse network includes a plurality of third synapse systems, which are subordinated to the first synapse system.

5. The neuromorphic device according to claim 3, wherein the second synapse network includes a plurality of second synapse systems, which are subordinated to one of the third synapse systems.

6. The neuromorphic device according to claim 3, wherein a data pattern learned by the first synapse network is transmitted to the third synapse network and saved by the third synapse network.

7. The neuromorphic device according to claim 6, wherein the data pattern saved by the third synapse network is transmitted to the first synapse network and updated by the first synapse network.

8. The neuromorphic device according to claim 1, wherein the first synapse network exclusively learns a data pattern.

9. The neuromorphic device according to claim 1, wherein the first synapse network is potentiated and depressed by first electrical set and reset pulses, the first set and reset pulses having a higher voltage, a larger current, a longer input time, or a larger number of input times than second electrical set and reset pulses used for potentiating and depressing the second synapse network, respectively.

10. The neuromorphic device according to claim 1, further comprising:
a pre-processor disposed between the input device and the neural network,
wherein the pre-processor distributes a data pattern to be learned to the first synapse network.

11. A neuromorphic device comprising:
an input device;
a neural network electrically coupled to the input device; and
an output device electrically coupled to the neural network,
wherein the neural network includes a first synapse network having a first learning speed and a second synapse network having a second learning speed that is slower than the first learning speed.

12. The neuromorphic device according to claim 11,
wherein the first synapse network includes a plurality of first synapse systems that have the first learning speed, and
wherein the second synapse network includes a plurality of second synapse systems that have the second learning speed.

13. The neuromorphic device according to claim 11, wherein the second synapse network includes a plurality of second synapse systems that are subordinated to the first synapse network.

14. The neuromorphic device according to claim 11,
wherein the neural network further includes a third synapse network disposed between the first synapse network and the second synapse network, and
wherein the third synapse network has a third learning speed that is slower than the first learning speed and faster than the second learning speed.

15. The neuromorphic device according to claim 14, wherein the third synapse network includes a plurality of third synapse systems that are subordinated to the first synapse network.

16. The neuromorphic device according to claim 14, wherein the second synapse network includes a plurality of second synapse systems that are subordinated to the third synapse network.

17. The neuromorphic device according to claim 14,
wherein the first synapse network exclusively learns a data pattern, and
wherein the data pattern learned by the first synapse network is transmitted to the third synapse network and saved by the third synapse network.

18. A neuromorphic device comprising:
an input device;
a neural network electrically coupled to the input device; and
an output device electrically coupled to the neural network,
wherein the neural network includes a first synapse network having a first data retention capability and a second synapse network having a second data retention capability that is better than the first data retention capability.

19. The neuromorphic device according to claim 18,
wherein the neural network further includes a third synapse network disposed between the first synapse network and the second synapse network, and
wherein the third synapse network has a third data retention capability that is better than the first data retention capability and worse than the second data retention capability.

20. The neuromorphic device according to claim 19, wherein the third synapse system is potentiated and depressed by third electrical set and reset pulses, respectively,
wherein the third electrical set and reset pulses have a higher voltage, a larger current, a longer input time, or a larger number of input times than first electrical set and reset pulses used for potentiating and depressing the first synapse system, respectively, the third electrical set and reset pulses having a lower voltage, a smaller current, a shorter input time, or a smaller input number of times than second electrical set and reset pulses used for potentiating and depressing the second synapse system, respectively.
